(19) United States
(12) Patent Application Publication
(10) Pub. No.: US 2026/0149184 A1
(43) Pub. Date: May 28, 2026

(54) PRINTED HIGH-ISOLATION MULTI-FEED ANTENNA

(71) Applicant: Intel Corporation, Santa Clara, CA (US)

(72) Inventors: Seong-Youp John SUH, Portland, OR (US); Tae Young YANG, Portland, OR (US); Oren Ezra AVRAHAM, Givat Shmuel (IL); Ofir DEGANI, Haifa (IL); Bryce D. HORINE, Portland, OR (US); Harry SKINNER, Beaverton, OR (US); Walid EL HAJJ, Antibes (FR); Serge DAO, Vallauris (FR); Jayprakash THAKUR, Bangalore (IN); Richard PERRY, Portland, OR (US); Ronen KRONFELD, Shoham (IL)

(21) Appl. No.: 18/956,041

(22) Filed: Nov. 22, 2024

(51) Int. Cl. H01Q 13/10; H01Q 5/40; H01Q 9/30

(52) U.S. Cl. CPC H01Q 13/10; H01Q 5/40; H01Q 9/30

(57) ABSTRACT

A multi-feed antenna device includes a monopole antenna, having an antenna portion; a first antenna extension of a first length, extending from the antenna portion; a second antenna extension of a second length, less than the first length, extending from the antenna portion; a slot antenna, including a first slot of third length; a second slot of a fourth length, greater than the third length; a first antenna feed, coupled to the monopole antenna; a second antenna feed, coupled to the slot antenna; and a ground plane, common to both the monopole antenna and the slot antenna.

### TECHNICAL FIELD

Various aspects of this disclosure generally relate to multi-feed antenna devices that include a monopole antenna and a slot antenna.

### BACKGROUND

Existing, printable, multi-feed antennas exhibit poor or inadequate isolation, which necessitates the use of filters, thereby increasing cost and complexity, while also introducing undesirable insertion loss. Moreover, such antennas may present manufacturing difficulties due to their complex integration processes, thereby resulting in challenges manufacturing such antennas at high volumes.

It is desired to create a printed, multi-feed antenna with high isolation between the feeds that can be manufactured in high volumes.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a multi-feed antenna device;

FIG. 2 depicts an antenna fabricated on an FR4 substrate;

FIG. 3 depicts a first mini-UFL cable soldered to the monopole antenna;

FIG. 4 depicts a second mini-UFL cable soldered to the half-slot antenna of FIG. 1;

FIG. 5 depicts results of an antenna simulation with return losses of half-slot antenna with different solvers and mesh types;

FIG. 6 depicts simulated return losses of the monopole antenna with different solvers and mesh types;

FIG. 7 depicts simulated isolation between the half-slot and the monopole antenna;

FIG. 8 depicts measured S-parameter results of the high isolation, dual feed antenna disclosed herein;

FIG. 9 depicts antenna simulated total efficiency of the half-slot antenna and monopole antenna;

FIG. 10 depicts a peak gain of both the half-slot antenna and the monopole antenna;

FIG. 11 depicts envelope correlation coefficients of the dual feed antenna disclosed herein;

FIG. 12 depicts an alternative design of the dual-feed antenna;

FIG. 13 depicts simulation results for the antenna of FIG. 12;

FIG. 14 depicts the dual-feed antenna with a bended design;

FIG. 15 depicts simulation results (S-parameters) of the antenna of FIG. 14;

FIG. 16 depicts total efficiency of the antenna of FIG. 14;

FIG. 17 depicts the maximum gain over frequency of the antenna of FIG. 14;

FIG. 18 depicts the envelope correlation coefficient of the antenna of FIG. 14; and

FIG. 19 depicts a multi-feed antenna device according to an aspect of the disclosure.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

Throughout this disclosure, the terms monopole antenna and slot antenna are used. The skilled person will appreciate that a monopole antenna includes a conducting rod or wire that is capable of radiating electromagnetic energy. The monopole antenna may, in some configurations, be configured to be a quarter of a wavelength long (e.g., as long as a quarter of a wavelength desired for radiation, although this should be understood only as an option, since other configurations (e.g., a half-wavelength or a full-wavelength) are also conceivable, and since a given antenna may be required to radiate many different frequencies). A monopole antenna may exhibit an omnidirectional radiation pattern in the horizontal plane. A slot antenna, in contrast, includes a slot in a metal conductor or waveguide. The slot antenna may radiate omnidirectionally or directionally based on the design. A horizontally placed slot antenna yields a vertical polarization, whereas a vertically placed slot yields a horizontal polarization. In this manner, a monopole antenna and a slot antenna placed along the same axis will be orthogonally polarized relative to one another.

The combination of monopole antenna and slot antenna along a common axis can be used to leverage their different radiation patterns and polarization characteristics so as to reduce or minimize interference and coupling between the antennas. Furthermore, placing a high frequency monopole antenna along the same axis as a comparatively low frequency slot antenna will further reduce interference, since these antennas will be transmitting at markedly different frequencies. In this manner, the antennas can be implemented together with good isolation.

Throughout this disclosure, the terms “slot” and “half-slot” are used to describe antennas. It is understood that a half-slot antenna is a sub-group of a slot-antenna. To the extent that an antenna is described herein as being a slot antenna, this should be understood as describing a mechanism by which the antenna radiates (e.g. via a slot, as opposed to radiating via a conductor as in a monopole antenna). The term “slot antennas” should also be understood to include half-slot antennas.

The antenna and manufacturing process described herein allows for high-volume manufacturing of high isolation (HI) multi-Feed (which may be a dual-feed (DF)) antennas. The antennas may be printed, such as on low-cost printed circuit board (PCB), flexible printed circuit board (FPC), or standard FR4 PCB substrate. Because the antennas disclosed herein may be printed, they may be advantageous over non-printed antennas, such as, for example, 3-D metal-stamped HI DF antennas and can be manufactured relatively inexpensively.

The antennas disclosed herein may operate in low band (LB) (2.4 GHz) operation with isolation of greater than 40 dB instantaneously over the broadband of high band (HB) (5 GHz)/ultra high band (UHB) (6 GHz). The antenna may also yield a high isolation of >20 dB at LB (2.4 GHz) and >26 dB isolation at HB/UHB with different dimensions but with the same antenna concept. The printed, high-isolation design may also permit increased ease of antenna integration (e.g., in a laptop) by bending the antenna design printed with a flexible FPC materials.

Once printed, the remaining fabrication process is uncomplicated and requires only soldering a cable (e.g., a legacy mini-UFL cable, which may already be used in standard antenna fabrication and can therefore incorporated with additional cost). In this manner, manufacture can occur simply and inexpensively. The exceptional 40 dB isolation enables a high-performance, comparatively low-cost, dual-radio connectivity (Wi-Fi/Bluetooth) that supports improved throughput and latency, compared to conventional options.

The antenna as disclosed herein may include a tri-band (LB/HB/UHB), half-slot antenna, a tri-band (LB/HB/UHB) monopole antenna, and a ground plane with a decoupling design. The two antennas may be positioned in a side-by-side configuration at opposite sides of the common ground sharing the ground plane each other. The antennas may be arranged in complementary pairs that are orthogonally polarized relative to each other, thereby offering high isolation. Despite this high isolation, the antennas can nevertheless be printed on the same plane of a substrate in a compact form factor. Small cutout areas in the ground plane may play an additional role in decoupling conducted currents between the two antennas, which may improve an isolation on top of the orthogonal polarization of the antennas.

In one exemplary configuration, the antennas may be fed with legacy mini-UFL coax cables for both antennas and can be soldered through a simple low-cost fabrication process. A printed transmission line design for the half-slot antenna may play a meaningful role in achieving the tri-band (LB/HB/UHB) operation of the half-slot antenna and the high isolation.

Depending on the desired integration with laptops or mobile devices, the antennas may be bent toward a side of the radiofrequency (RF) window when the antenna is printed on a flexible PCB, such as an FPC. The HI multi-feed antennas as disclosed herein may optionally be used with mainstream products that require a single multi-feed antenna instead of integrating and routing cables to multiple legacy (single-feed) antennas.

In some configurations, it may be desirable to encase the antenna in a metal cavity. Such a metal cavity may isolate the antenna from the materials near the antenna, thereby simplifying integration.

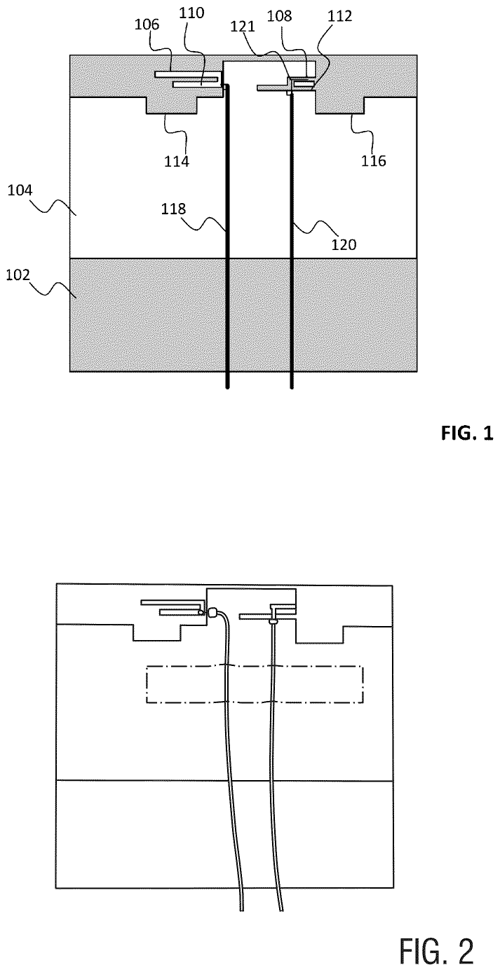

FIG. 1 depicts a multi-feed antenna device that includes a substrate 102, a ground plane 104, a printed monopole antenna 106, and a half-slot antenna 108. Although many configurations are possible, in one exemplary configuration, FR4 (Dk=4.4, tan δ=0.02) having a thickness of 1.6 mm was used for validation purposes. The printed monopole antenna 106 and the half-slot antenna 108 may be positioned in a side-by-side configuration as depicted herein. They may share the ground plane 104 to achieve a compact form factor.

Tri-band operation for both antennas may be achieved by adding additional half-slot and monopole elements to the original antenna elements. For example, in FIG. 1 an additional monopole antenna element 110 is added to the monopole antenna 106, and an additional half-slot element 112 is added to the half-slot antenna 108. That is, each of half-slot antenna 108 and the additional half-slot element 112 are or function as half-slot antennas. In this manner, they are complementary antennas of the monopole antenna, which itself if half of a dipole antenna. The additional half-slot element 112 may be configured for low band use, whereas half-slot antenna 108 may be configured for high band and/or ultra-high band use. These additional elements (whether alone or in combination with the above printed monopole antenna 106 and half-slot antenna 108 may include optimized dimensions tuned at the low band (LB), the high-band (HB), and/or the ultra-high-band (UHB) respectively.

The ground plane 104 may include a first cutout 114 beneath the printed monopole antenna 106 and/or a second cutout 116 beneath the half-slot antenna 108. The printed monopole antenna 106 may be electrically conductively connected (e.g., directly connected) to a first antenna feed 118, and the slot antenna 108 may be connected to a second antenna feed 120 via an excitation conductor 121. The half-slot antenna 108 may include a resonator (not depicted), and the second antenna feed 120 may be electrically conductively connected (e.g., directly connected) to the resonator, which may be located within the slot antenna 108. The relationship between the resonator and the slot antenna will be described in greater detail below.

Although the skilled person will appreciate that other dimensions are possible, an optional, exemplary set of dimensions may include a distance between an outermost position of the printed monopole antenna 106 and the half-slot antenna 108 being 41.12 mm; a distance between a topmost portion of the ground plane 104 and a bottommost portion of the ground plane 104 being 41.30 mm; a height of the ground plane above the notches (e.g. a high of the portion of the ground plane containing the printed monopole antenna and the slot antenna above the portion where the notches are located) being 10.00 mm; a depth of the first slot being 4.10 mm; and a height of the substrate 102 extending beyond (e.g. beneath in FIG. 1) the ground plane 104 being 28.70 mm.

FIG. 2 depicts a photograph of an antenna fabricated on an FR4 substrate. The skilled person will appreciate that FR4 is a composite material made of woven fiberglass cloth and an epoxy resin binder. Although this is made with FR4, it is noted that any circuit board material may be used. The circuit board material may be a material for a printed circuit board, and the antennas described herein may be printed antennas (e.g., the monopole antenna may be printed; at least the resonator of the half-slot antenna may be printed).

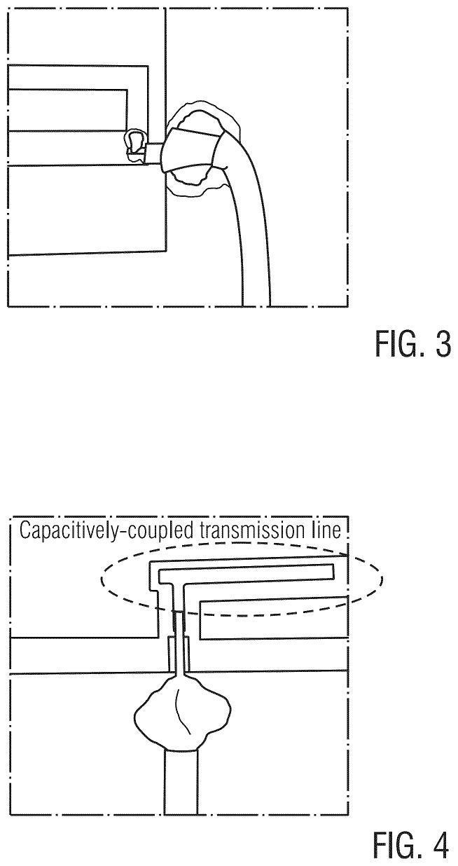

The antennas may be fed with cables. In some configurations, coaxial cables may be used. In certain instances, it may be desirable to use legacy mini-UFL coaxial cables, as these may be soldered through a simple and low-cost fabrication process and may otherwise reduce the cost of materials. FIG. 3 depicts a first mini-UFL cable soldered to the monopole antenna consisting of 106 and 110 in FIG. 1. This may be understood as the first antenna feed and may be configured to send a first electrical signal to be radiated by the monopole antenna. FIG. 4 depicts a second mini-UFL cable soldered to the half-slot antenna of FIG. 1, which may be understood as the second antenna feed. Specifically, the half-slot antenna may include a printed, capacitively-coupled transmission line, to which the second antenna feed may be soldered. This capacitively-coupled transmission line may play an important role in achieving the wide tri-band (LB/HB/UHB) operation as the half-slot antenna with the single coaxial cable feed.

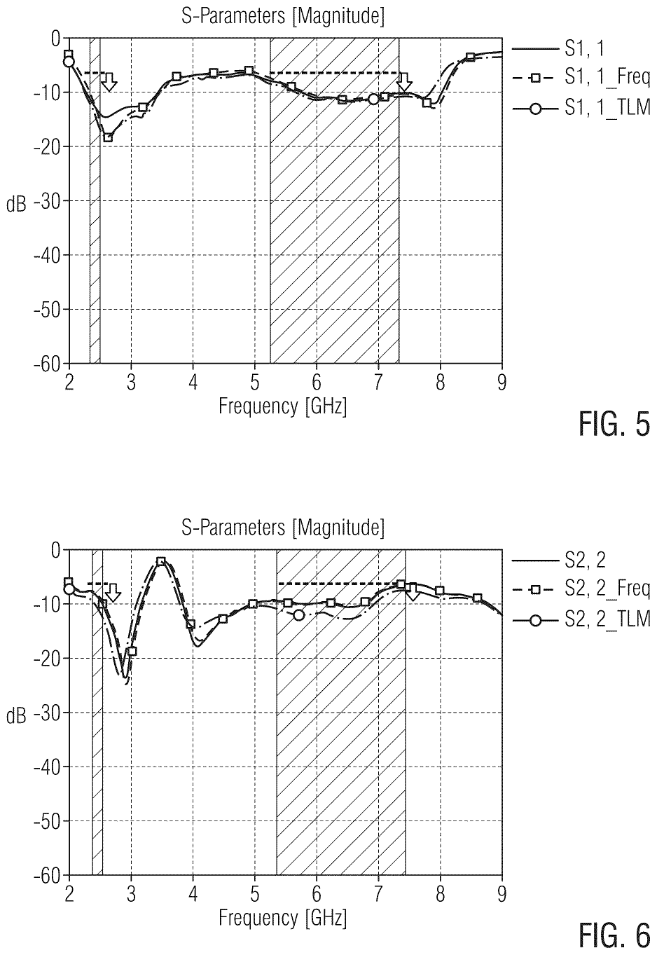

FIG. 5 depicts results of an antenna simulation with return losses of half-slot antennas (S11) with different electromagnetic solvers. Return losses of each antenna are >6.8 dB and >6.1 dB for the half-slot and monopole antennas respectively.

| Simulation methods | | |
|---|---|---|
| (Line type) | Solver type | Mesh type |
| Finite Integration | Time domain | Hexahedral |
| Technique | | |
| (Solid line) | | |
| Finite Element Method | Frequency domain | Tetrahedral |
| (Square dash) | | |
| Transmission-Line | Time domain | Hexahedral |
| Matrix method | | |
| (Circle dash dot) | | |

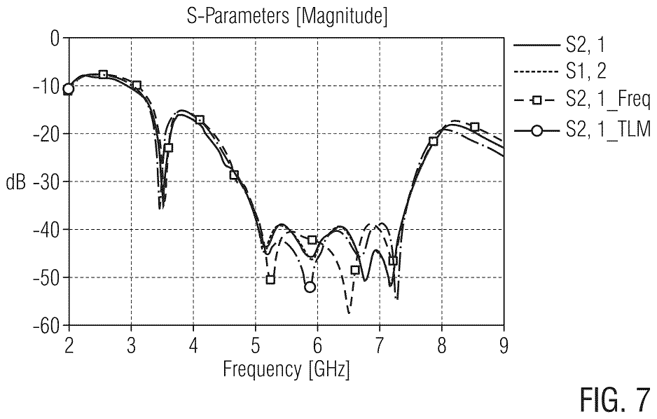

FIG. 6 depicts simulated return losses (S22) of the monopole antenna with different solvers and mesh types. FIG. 7 depicts simulated isolation (|S21|/|S12|>39 dB at HB/UHB) between the monopole antenna and half-slot antenna. As can be seen, the multi-feed, multi-band antenna proposed herein that includes both a printed monopole antenna and a half-slot antenna provides both high return loss and high isolation.

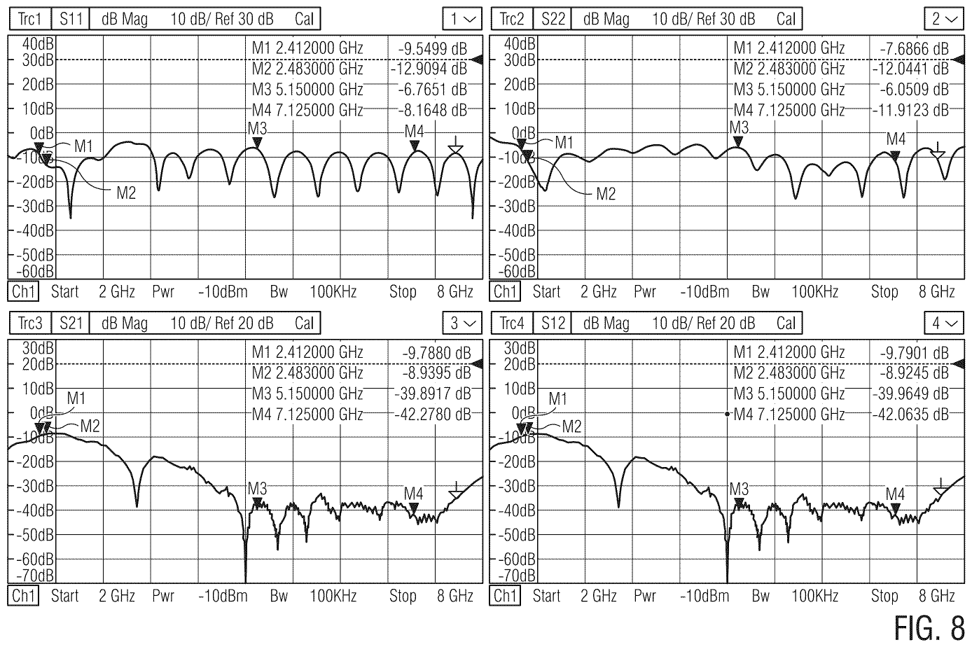

FIG. 8 depicts measured and simulated S-parameter results of the high isolation, dual feed antenna disclosed herein. As can be seen, the measured return loss of the half-slot antenna (S11) is >6.8 dB, and the measured return loss of the monopole antenna (S22) is >6.1 dB. The measured isolation result, showing >38 dB isolation with exception of 33 dB isolation at 5.8 GHz, validate the simulated isolation result.

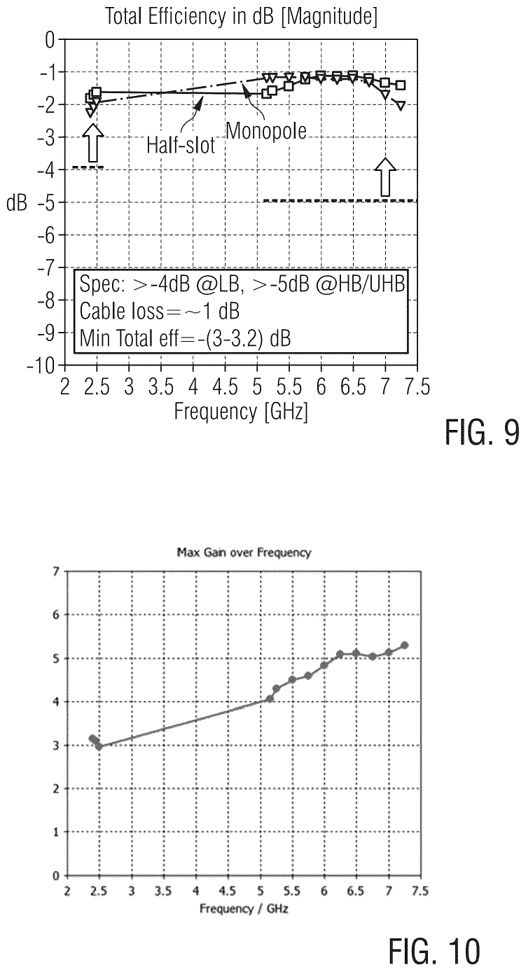

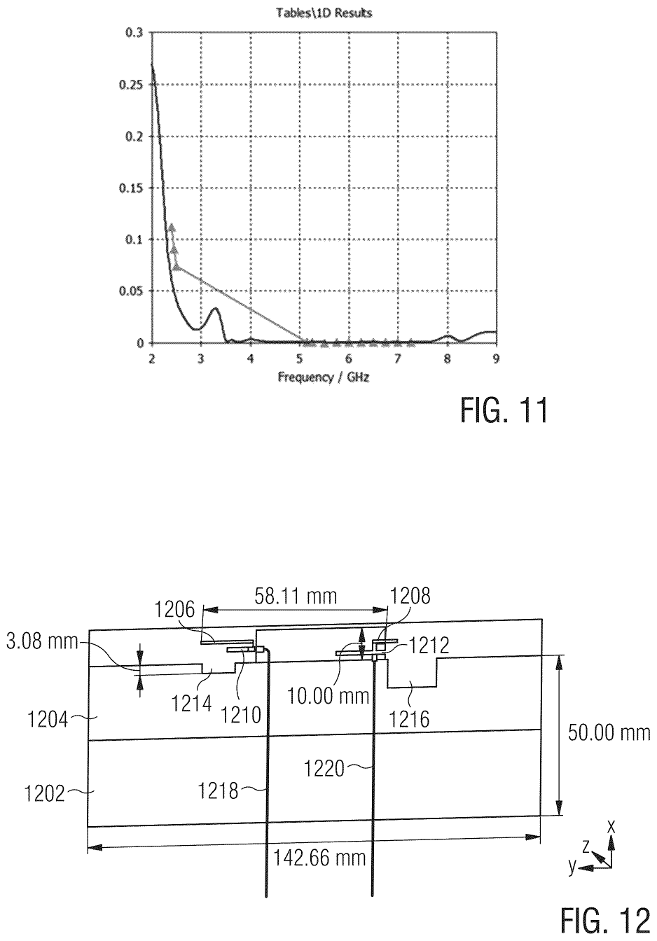

FIG. 9 depicts antenna simulated the total efficiency of the half-slot antenna and monopole antenna. As can be seen in this figure, the multi-feed antenna disclosed herein demonstrates good performance with a minimum total efficiency of −3 to −3.3 dB. FIG. 10 depicts a peak gain of both the monopole antenna and the slot antenna. FIG. 11 depicts envelope correlation coefficients (ECCs) of the dual feed antenna disclosed herein.

FIG. 12 depicts an alternative design of the dual-feed antenna demonstrating a high isolation for both LB (2.4 GHz) and HB/UHB (5.15-7.25 GHZ). This alternative design includes a substrate 1202, a ground plane 1204, a printed monopole antenna 1206, and a half-slot antenna 1208. An additional monopole antenna element 1210 is added to the monopole antenna 1206, and an additional half-slot element 1212 is added to the half-slot antenna 1208. These additional elements (whether alone or in combination with the above printed monopole antenna 1206 and half-slot antenna 1208 may include optimized dimensions tuned at low band (LB), high-band (HB), and/or ultra-high-band (UHB) respectively.

The ground plane 1204 may include a first cutout 1214, beneath the printed monopole antenna 1206 and/or a second cutout 1216 beneath the slot antenna 1208. The printed monopole antenna 1206 may be electrically conductively connected (e.g., directly connected) to a first antenna feed 1218, and the slot antenna 1208 may be connected to a second antenna feed 1220. The slot antenna 1208 may include a resonator (not depicted), and the second antenna feed 1220 may be electrically conductively connected (e.g., directly connected) to the resonator, which may be located within the slot antenna 1208. The relationship between the resonator and the slot antenna will be described in greater detail below.

Although the skilled person will appreciate that other dimensions are possible, an exemplary set of dimensions is provided in FIG. 12. In particular, a distance between an outermost portion of the printed monopole antenna 1206 and the slot antenna 1208 is 58.11 mm; a distance between a topmost portion of the ground plane 1204 and a bottommost portion of the substrate 1202 is 50.00 mm; a depth of the first slot is 3.08 mm; and a width of the ground plane 1204 and substrate 1202 is 142.66 mm.

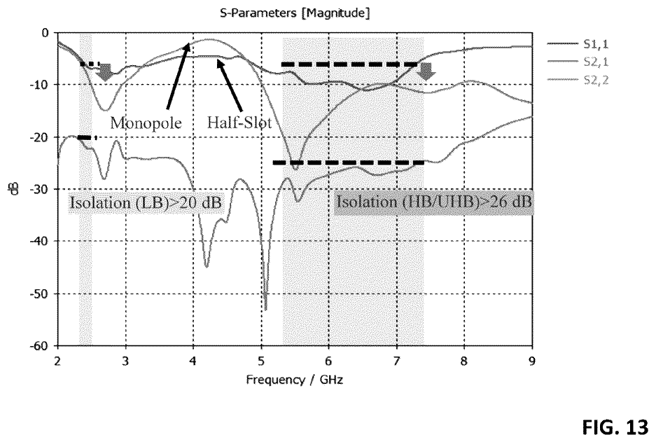

This design shows >20 dB isolation at LB and >26 dB isolation at HB/UHB with the same antenna design concept previously described in this application, although with different dimensions. The simulated antenna characteristics demonstrate a feasibility of the printed high-isolation dual-feed antenna that can cover a full band of LB, HB, and UHB. This high-isolation, dual-feed antenna can be used with Wi-Fi and/or Bluetooth while achieving satisfactory isolation at both LB (at least >20 dB isolation) and HB/UHB (at least >25 dB isolation). FIG. 13 depicts simulation results for the high-isolation, dual-feed antenna of FIG. 12, with isolation in the LB of >20 dB isolation in the HB/UHB of >26 dB.

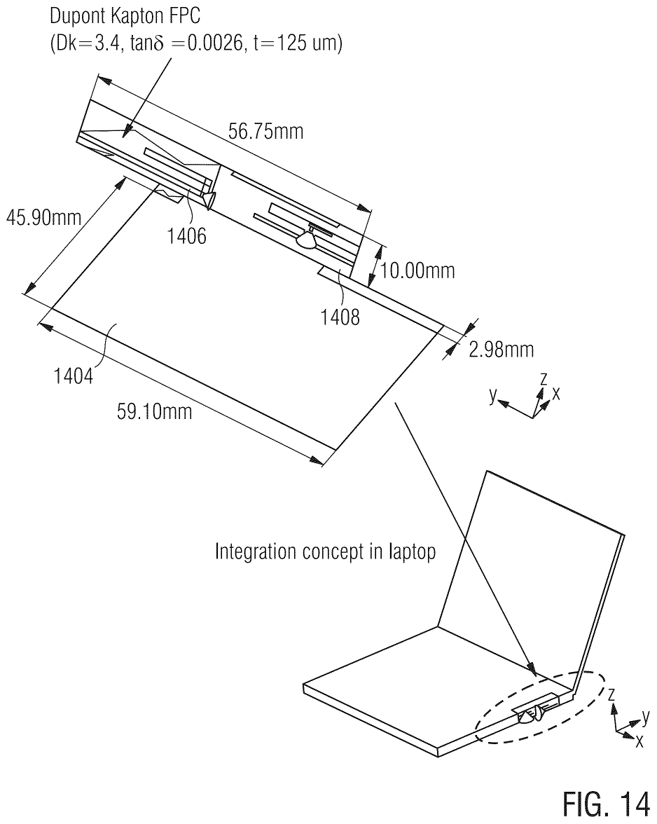

The antenna can be also configured with a bended design to improve antenna integration for thin laptops or other mobile devices. FIG. 14 depicts the dual-feed antenna with the bended design, according to an aspect of the disclosure. In this figure, the ground plane 1404 may be oriented along a different plane than the printed monopole antenna 1406 and the slot antenna 1408. In an exemplary configuration, the antenna may be printed on a Dupont Kapton flexible printed circuit board (FPC) material (Dk=3.4, tanδ=0.0026, thickness=125 um). Exemplary, albeit non-limiting, dimensions may include the ground plane 1404 measuring 59.10 mm by 45.90 mm; a distance between an outermost portion of the monopole antenna and an outermost portion of the half-slot antenna being 56.75 mm; a height of the metal conductor housing the half-slot antenna (e.g., a height of the ground plane extending above the bended area/extending above the slots) being 10.00 mm; and a depth of one or more of the slots being 2.98 mm.

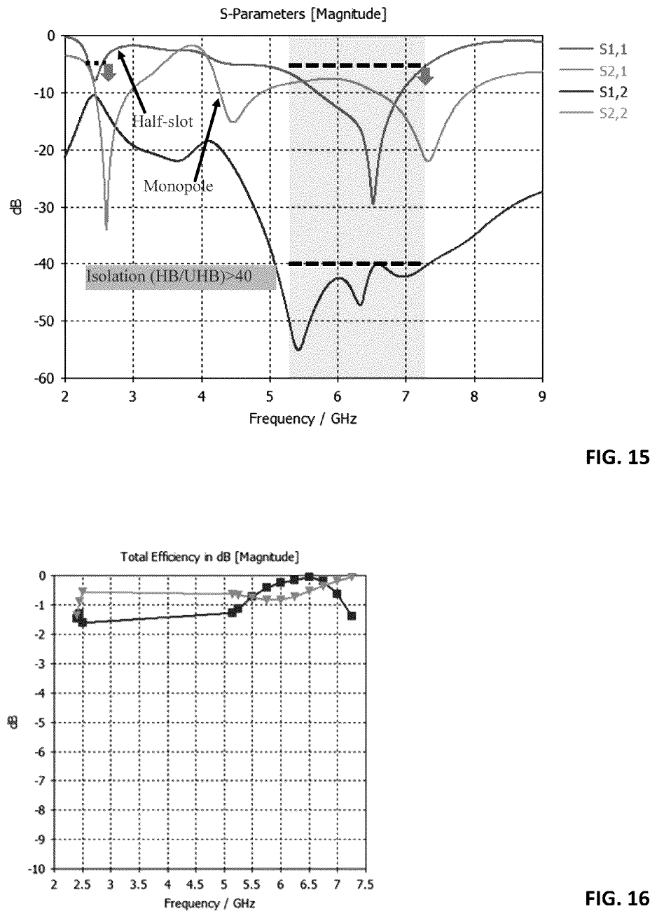

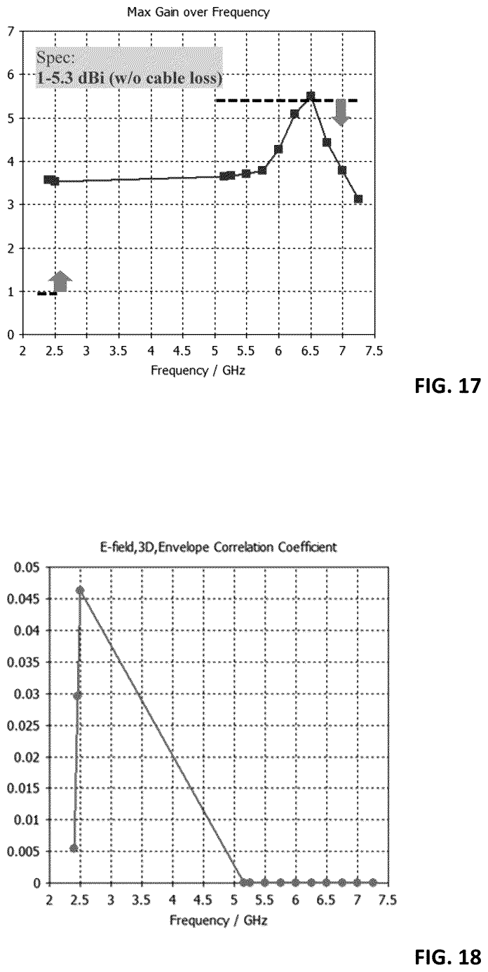

FIG. 15 depicts simulation results (S-parameters) of the antenna of FIG. 14. FIG. 16 depicts total efficiency of the antenna of FIG. 14. FIG. 17 depicts the maximum gain over frequency of the antenna of FIG. 14. FIG. 18 depicts the envelope correlation coefficient of the antenna of FIG. 14. The results of FIGS. 15-18 demonstrate that the antenna may achieve high isolation of >40 dB in the HB/UHB with the bended antenna configuration, as well as with the planar antennas described above.

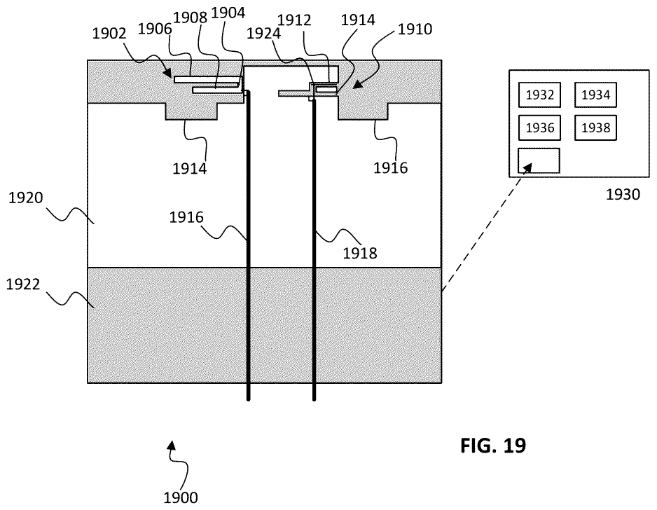

FIG. 19 depicts a multi-feed antenna device 1900 according to an aspect of the disclosure. The multi-feed antenna device 1900 includes a monopole antenna 1902. The monopole antenna 1902 includes an antenna portion 1904; a first antenna extension 1906 of a first length, extending from the antenna portion 1904; and a second antenna extension 1908 of a second length, less than the first length, extending from the antenna portion 1904. The multi-feed antenna device 1900 also includes a slot antenna 1910, which includes a first slot 1912 of third length; and a second slot 1914 of a fourth length, greater than the third length. The multi-feed antenna device 1900 further includes a first antenna feed 1916, coupled to the monopole antenna 1902, a second antenna feed 1918, coupled to the slot antenna 1910; and a ground plane 1920, common to both the monopole antenna 1902 and the slot antenna 1910. The multi-feed antenna device 1900 may be printed on a substrate 1922.

The slot antenna may include an exciting conductor 1924. The exciting conductor 1924 may be for capacitive coupling with the slot antenna. The exciting conductor may be made of metal or other electrically conductive material and may be positioned in the first slot. The second antenna feed may be coupled to the slot antenna by virtue of its being coupled to the exciting conductor.

The exciting conductor may include a first exciting conductor extension along a first longitudinal axis and a second exciting conductor extension along a second longitudinal axis, perpendicular to the first longitudinal axis, wherein the second exciting conductor extension is placed such that a first portion of the first exciting conductor extension is to a left side of the second exciting conductor extension, and a second portion of the first exciting conductor extension is to a right side of the second exciting conductor extension. That is, the first portion and the second portion may extend on either side of the second exciting conductor extension. The lengths of the first portion and the second portion may differ, and they may be selected to achieve a desired result.

In one optional configuration, the first antenna extension may have a first longitudinal axis, and the second slot may have a second longitudinal axis, such that the first longitudinal axis and the second longitudinal axis are parallel but non-overlapping. In this manner, two slots of differing lengths may be used for different frequencies and/or frequency bands. That is, a longer slot may be configured for lower frequencies, and a shorter slot may be configured for higher frequencies. It is of course possible for the two slots to be non-parallel; however, the use of parallel slots may simplify design and improve the overall isolation between the antennas.

The antenna may be configured such that the first antenna extension and the first slot are along a first longitudinal axis, and the second antenna extension and the second slot are along a second longitudinal axis. This alignment of an antenna extension and a slot along the same axis and the alignment of another antenna extension and another slot along another axis may improve isolation between the antenna elements.

The ground plane may be used in conjunction with the monopole antenna. The ground plane may be, or be part of, a conductor into which the slot antenna is cut. That is, the slot antenna may be in the ground plane for the monopole antenna. The ground plane may include one or more decoupling notches. For example, the ground plane may include a first decoupling notch, which may be configured to reduce a coupling of a current from the monopole antenna with the slot antenna. The ground plane may include a second decoupling notch, configured to reduce a coupling of a current from the slot antenna with the monopole antenna. The notches may disrupt surface currents within the ground plane, which may effectively interrupt or break a conductive path between the monopole and slot antennas. The notches can be designed to modify the current distribution in a targeted way. The notches may control where currents flow such that the notches guide the currents away from regions where coupling between the antennas would be more likely to occur. The notches may alter the impedance of the ground plane in the vicinity of the antennas, which may enhance isolation, such as by creating a higher impedance path between the monopole and slot antennas. The notches may also affect electromagnetic field distribution in the near-field region of the antennas, which may help prevent overlap between the electric and magnetic fields of the monopole and slot antennas, thereby reducing interaction.

The monopole antenna may be optionally formed from a monolithic conductor. In this manner, the monopole antenna may be printed as a monolithic conductor or may be otherwise formed as a monolithic conductor and placed into/on the antenna device.

Alternatively, the monopole antenna, the slot antenna, and the ground plane may be formed from a conductive sheet, common to the monopole antenna, the slot antenna, and the ground plane. In this manner, the conductive sheet may be cut to form the monopole antenna, which will be placed such that it does not directly connect to the ground plane. The notches may be formed in the ground plane, and the slot antennas may be cut into the ground plane.

In an optional configuration, the antenna device may be formed on a flexible, conductive sheet, such that the flexible, conductive sheet may be bent. In this manner, the monopole antenna and the slot antenna can be formed along a first plane, and at least a portion of the ground plane is formed along a second plane that intersects with the first plane. That is, there can be a bend such that the antennas are placed along a first plane, and that at least a portion of the ground plane is along a second plane. The first plane and the second plane may intersect. In some configurations, the first plane and the second plane may be perpendicular. In other configurations, the conductive sheet may be configurable such that the first plane and the second plane may be identical or that the first plane and the second plane intersect, or that the conductive sheet can be bent or unbent to switch between these two configurations.

As stated above, the monopole antenna may be optionally configured as a tri-band antenna, which may be configured to transmit and/or receive in a low-band, high-band, and ultra-high-band frequency range. Here, it will be appreciated that these band distinctions may be generally understood to reflect any three bands of different frequencies, such that the low band includes the lowest frequencies of the tri-band operations; the ultra-high-band includes the highest frequencies of the tri-band operations; and the high-band includes frequencies between the low-band and the ultra-high-band. In some configurations, the low-band may optionally correspond to frequencies of approximately 2.4 GHz; the high-band may optionally correspond to frequencies of approximately 5 GHz; and the ultra-high-band may optionally correspond to frequencies of approximately 6 GHz.

In an optional configuration, the first antenna feed and the second antenna feed may be configured as coaxial cables. These may be, for example, mini-UFL coaxial cables, which may already be available in many legacy applications. However, any coaxial cable may be used. It is, of course, not necessary to use a coaxial cable for the antenna feed, and the skilled person will appreciate that alternative cable types may be utilized.

In an optional configuration, any of the monopole antenna, the slot antenna, or the ground plane may be printed on a flexible printed circuit board. In this manner, the flexible circuit board may be flexed or bent, such as to accommodate the geography/form of a device (e.g., of a laptop, of a tablet, of a mobile phone, of a wearable device). In this manner, the structural relationship of one or both of the monopole antenna and the slot antenna may be changed relative to the ground plane and/or the notches.

The configuration disclosed herein may provide a high level of isolation between the monopole antenna and the slot antenna. This may be due at least in part to the orthogonal polarization of the monopole antenna and the slot antenna relative to one another. The isolation may be further aided by the placement of a lower band monopole antenna in line with (e.g., along a common axis with) a higher band slot antenna and the placement of a higher band monopole antenna in line with (e.g., along a common axis with) a lower band slot antenna. In this manner, the monopole antenna and the slot antenna may exhibit at least 30 dB of isolation relative to one another. Given this isolation, the multi-feed antenna device may simultaneously transmit a first data feed over the monopole antenna and a second data feed over the slot antenna.

The multi-feed antenna disclosed herein may be incorporated in a device 1930 (the multi-feed antenna is depicted as an element of device 1930), which itself may include a processor 1932 and a baseband modem 1934. The device 1930 may further include a radiofrequency front end 1936 and/or a radiofrequency transceiver 1938. The device 1930 may be or include a laptop, a tablet computer, a mobile phone (e.g., a smartphone), a wearable device, or an internet of things device.

In the following, additional aspects of the disclosure will be described by way of example:
In Example 1, a multi-feed antenna device, including a monopole antenna, including an antenna portion; a first antenna extension of a first length, extending from the antenna portion; a second antenna extension of a second length, less than the first length, extending from the antenna portion; a slot antenna, including: a first slot of third length; a second slot of a fourth length, greater than the third length; a first antenna feed, coupled to the monopole antenna; a second antenna feed, coupled to the slot antenna; and a ground plane, common to both the monopole antenna and the slot antenna.
In Example 2, the multi-feed antenna device of Example 1, wherein the slot antenna further includes an exciting conductor, positioned in the first slot, and configured to capacitively couple with the slot antenna; and wherein the second antenna feed being coupled to the slot antenna includes the second antenna feed being coupled to the exciting conductor.
In Example 3, the multi-feed antenna device of Example 2, wherein the exciting conductor includes a first exciting conductor extension along a first longitudinal axis and a second exciting conductor extension along a second longitudinal axis, perpendicular to the first longitudinal axis, and wherein the second exciting conductor extension is placed such that a first portion of the first exciting conductor extension is to a left side of the second exciting conductor extension, and a second portion of the first exciting conductor extension is to a right side of the second exciting conductor extension.
In Example 4, the multi-feed antenna device of any one of Examples 1 to 3, wherein the first antenna extension has a first longitudinal axis; wherein the second slot has a second longitudinal axis; and wherein the first longitudinal axis and the second longitudinal axis are parallel but non-overlapping.
In Example 5, the multi-feed antenna device of any one of Examples 1 to 4, wherein the first antenna extension and the first slot are along a first longitudinal axis, and wherein the second antenna extension and the second slot are along a second longitudinal axis.
In Example 6, the multi-feed antenna device of any one of Examples 1 to 5, further including a first decoupling notch in the ground plane, configured to reduce a coupling of a current from the monopole antenna with the slot antenna; and a second decoupling notch in the ground plane, configured to reduce a coupling of a current from the slot antenna with the monopole antenna.
In Example 7, the multi-feed antenna device of any one of Examples 1 to 6, wherein the monopole antenna is formed from a monolithic conductor.
In Example 8, the multi-feed antenna device of any one of Examples 1 to 7, wherein the monopole antenna, the slot antenna, and the ground plane are formed from a conductive sheet, common to the monopole antenna, the slot antenna, and the ground plane.
In Example 9, the multi-feed antenna device of Example 8, wherein the conductive sheet is bent such that the monopole antenna and the slot antenna are formed along a first plane, and at least a portion of the ground plane is formed along a second plane that intersects with the first plane.
In Example 10, the multi-feed antenna device of any one of Examples 1 to 9, wherein the monopole antenna is configured as a tri-band antenna, configured to transmit and/or receive in a low-band, high-band, and ultra-high-band.
In Example 11, the multi-feed antenna device of any one of Examples 1 to 10, wherein the slot antenna is configured as a tri-band antenna, configured to transmit and/or receive in a low-band, high-band, and ultra-high-band.
In Example 12, the multi-feed antenna device of any one of Examples 1 to 11, wherein the monopole antenna and the slot antenna are configured to radiate in an orthogonally polarized manner relative to one another.
In Example 13, the multi-feed antenna device of any one of Examples 1 to 12, wherein the first antenna feed and the second antenna feed are configured as coaxial cables.
In Example 14, the multi-feed antenna device of any one of Examples 1 to 13, further including a flexible printed circuit board, wherein any of the monopole antenna, the slot antenna, and the ground plane are printed on the flexible printed circuit board.
In Example 15, the multi-feed antenna device of any one of Examples 1 to 14, wherein the monopole antenna and the slot antenna exhibit at least 30 dB of isolation relative to one another.
In Example 16, the multi-feed antenna device of any one of Examples 1 to 15, wherein the multi-feed antenna device is configured to simultaneously transmit a first data feed over the monopole antenna and a second data feed over the slot antenna.
In Example 17, a device including: a processor; a baseband modem; a radiofrequency transceiver; a radiofrequency front-end; and the multi-feed antenna device of any one of Examples 1 to 16; and wherein processor is configured to control the baseband modem to send a wireless signal over the multi-feed antenna device.
In Example 18, a multi-feed antenna device, including: a first electromagnetic radiation means, including: a first portion; a first extension of a first length, extending from the first portion; a second extension of a second length, less than the first length, extending from the first portion; a second electromagnetic radiation means, including: a first slot of third length; a second slot of a fourth length, greater than the third length; a first signal supply means, coupled to the first electromagnetic radiation means; a second signal supply means, coupled to the second electromagnetic radiation means; and a grounding means, common to both first electromagnetic radiation means and the second electromagnetic radiation means.
In Example 19, the multi-feed antenna device of Example 18, wherein the second electromagnetic radiation means further includes an exciting conductor, positioned in the first slot, and configured to capacitively couple with the second electromagnetic radiation means; and wherein the second signal supply means being coupled to the second electromagnetic radiation means includes the second signal supply means being coupled to the exciting conductor.
In Example 20, the multi-feed antenna device of Example 19, wherein the exciting conductor includes a first exciting conductor extension along a first longitudinal axis and a second exciting conductor extension along a second longitudinal axis, perpendicular to the first longitudinal axis, and wherein the second exciting conductor extension is placed such that a first portion of the first exciting conductor extension is to a left side of the second exciting conductor extension, and a second portion of the first exciting conductor extension is to a right side of the second exciting conductor extension.
In Example 21, the multi-feed antenna device of any one of Examples 18 to 20, wherein the first extension has a first longitudinal axis; wherein the second slot has a second longitudinal axis; and wherein the first longitudinal axis and the second longitudinal axis are parallel but non-overlapping.
In Example 22, the multi-feed antenna device of any one of Examples 18 to 21, wherein the first extension and the first slot are along a first longitudinal axis, and wherein the second extension and the second slot are along a second longitudinal axis.
In Example 23, the multi-feed antenna device of any one of Examples 18 to 22, further including a first decoupling notch in the grounding means, configured to reduce a coupling of a current from the first electromagnetic radiation means with the second electromagnetic radiation means; and a second decoupling notch in the grounding means, configured to reduce a coupling of a current from the second electromagnetic radiation means with the first electromagnetic radiation means.
In Example 24, the multi-feed antenna device of any one of Examples 18 to 23, wherein the first electromagnetic radiation means is formed from a monolithic conductor.
In Example 25, the multi-feed antenna device of any one of Examples 18 to 24, wherein the first electromagnetic radiation means, the second electromagnetic radiation means, and the grounding means are formed from a conductive sheet, common to the first electromagnetic radiation means, the second electromagnetic radiation means, and the grounding means.
In Example 26, the multi-feed antenna device of Example 25, wherein the conductive sheet is bent such that the first electromagnetic radiation means and the second electromagnetic radiation means are formed along a first plane, and at least a portion of the grounding means is formed along a second plane that intersects with the first plane.
In Example 27, the multi-feed antenna device of any one of Examples 18 to 26, wherein the first electromagnetic radiation means is configured as a tri-band antenna, configured to transmit and/or receive in a low-band, high-band, and ultra-high-band.
In Example 28, the multi-feed antenna device of any one of Examples 18 to 27, wherein the second electromagnetic radiation means is configured as a tri-band antenna, configured to transmit and/or receive in a low-band, high-band, and ultra-high-band.
In Example 29, the multi-feed antenna device of any one of Examples 18 to 28, wherein the first electromagnetic radiation means and the second electromagnetic radiation means are configured to radiate in an orthogonally polarized manner relative to one another.
In Example 30, the multi-feed antenna device of any one of Examples 18 to 29, wherein the first signal supply means and the second signal supply means are configured as coaxial cables.
In Example 31, the multi-feed antenna device of any one of Examples 18 to 30, further including a flexible printed circuit board, wherein any of the first electromagnetic radiation means, the second electromagnetic radiation means, and the grounding means are printed on the flexible printed circuit board.
In Example 32, the multi-feed antenna device of any one of Examples 18 to 31, wherein the first electromagnetic radiation means and the second electromagnetic radiation means exhibit at least 30 dB of isolation relative to one another.
In Example 33, the multi-feed antenna device of any one of Examples 18 to 32, wherein the multi-feed antenna device is configured to simultaneously transmit a first data feed over the first electromagnetic radiation means and a second data feed over the second electromagnetic radiation means.
In Example 34, a device including: a processor; a baseband modem; and the multi-feed antenna device of any one of Examples 18 to 33; and wherein processor is configured to control the baseband modem to send a wireless signal over the multi-feed antenna device.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A multi-feed antenna device, comprising:
a monopole antenna, comprising:
an antenna portion;
a first antenna extension of a first length, extending from the antenna portion;
a second antenna extension of a second length, less than the first length, extending from the antenna portion;
a slot antenna, comprising:
a first slot of third length;
a second slot of a fourth length, greater than the third length;
a first antenna feed, coupled to the monopole antenna;
a second antenna feed, coupled to the slot antenna; and
a ground plane, common to both the monopole antenna and the slot antenna.

2. The multi-feed antenna device of claim 1, wherein the slot antenna further comprises an exciting conductor, positioned in the first slot, and configured to capacitively couple with the slot antenna; and
wherein the second antenna feed being coupled to the slot antenna comprises the second antenna feed being coupled to the exciting conductor.

3. The multi-feed antenna device of claim 2, wherein the exciting conductor comprises a first exciting conductor extension along a first longitudinal axis and a second exciting conductor extension along a second longitudinal axis, perpendicular to the first longitudinal axis, and wherein the second exciting conductor extension is disposed such that a first portion of the first exciting conductor extension is to a left side of the second exciting conductor extension, and a second portion of the first exciting conductor extension is to a right side of the second exciting conductor extension.

4. The multi-feed antenna device of claim 1, wherein the first antenna extension has a first longitudinal axis; wherein the second slot has a second longitudinal axis; and wherein the first longitudinal axis and the second longitudinal axis are parallel but non-overlapping.

5. The multi-feed antenna device of claim 1, wherein the first antenna extension and the first slot are along a first longitudinal axis, and wherein the second antenna extension and the second slot are along a second longitudinal axis.

6. The multi-feed antenna device of claim 1, further comprising a first decoupling notch in the ground plane, configured to reduce a coupling of a current from the monopole antenna with the slot antenna; and a second decoupling notch in the ground plane, configured to reduce a coupling of a current from the slot antenna with the monopole antenna.

7. The multi-feed antenna device of claim 1, wherein the monopole antenna, the slot antenna, and the ground plane are formed from a conductive sheet, common to the monopole antenna, the slot antenna, and the ground plane.

8. The multi-feed antenna device of claim 7, wherein the conductive sheet is bent such that the monopole antenna and the slot antenna are formed along a first plane, and at least a portion of the ground plane is formed along a second plane that intersects with the first plane.

9. The multi-feed antenna device of claim 1, wherein the monopole antenna is configured as a multi-band antenna, configured to transmit and/or receive in two or more of a low-band, high-band, and ultra-high-band and wherein the slot antenna is configured as a multi-band antenna, configured to transmit and/or receive in two or more of a low-band, high-band, and ultra-high-band.

10. The multi-feed antenna device of claim 1, wherein the monopole antenna and the slot antenna are configured to radiate in an orthogonally polarized manner relative to one another.

11. The multi-feed antenna device of claim 1, further comprising a flexible printed circuit board, wherein any of the monopole antenna, the slot antenna, and the ground plane are printed on the flexible printed circuit board.

12. The multi-feed antenna device of claim 1, wherein the multi-feed antenna device is configured to simultaneously transmit a first data feed over the monopole antenna and a second data feed over the slot antenna.

3. A device comprising:
a processor;
a baseband modem;
a radiofrequency front end device;
a radiofrequency transceiver; and
the multi-feed antenna device of claim 1; and
wherein processor is configured to control the baseband modem to send a wireless signal over the multi-feed antenna device.

14. A device, comprising:
a first electromagnetic radiation device, comprising:
a first portion;
a first extension of a first length, extending from the first portion;
a second extension of a second length, less than the first length, extending from the first portion;
a second electromagnetic radiation device, comprising:
a first slot of third length;
a second slot of a fourth length, greater than the third length;
a first signal supply device, coupled to the first electromagnetic radiation device;
a second signal supply device, coupled to the second electromagnetic radiation device; and
a grounding device, common to both first electromagnetic radiation device and the second electromagnetic radiation device.

15. The device of claim 14, wherein the second electromagnetic radiation device further comprises an exciting conductor, positioned in the first slot, and configured to capacitively couple with the second electromagnetic radiation device; and
wherein the second signal supply device being coupled to the second electromagnetic radiation device comprises the second signal supply device being coupled to the exciting conductor.

16. The device of claim 15, wherein the exciting conductor comprises a first exciting conductor extension along a first longitudinal axis and a second exciting conductor extension along a second longitudinal axis, perpendicular to the first longitudinal axis, and wherein the second exciting conductor extension is disposed such that a first portion of the first exciting conductor extension is to a left side of the second exciting conductor extension, and a second portion of the first exciting conductor extension is to a right side of the second exciting conductor extension.

17. The device of claim 14, wherein the first extension has a first longitudinal axis; wherein the second slot has a second longitudinal axis; and wherein the first longitudinal axis and the second longitudinal axis are parallel but non-overlapping.

18. The device of claim 14, wherein the first extension and the first slot are along a first longitudinal axis, and wherein the second extension and the second slot are along a second longitudinal axis.

19. The device of claim 14, further comprising a first decoupling notch in the grounding device, configured to reduce a coupling of a current from the first electromagnetic radiation device with the second electromagnetic radiation device; and a second decoupling notch in the grounding device, configured to reduce a coupling of a current from the second electromagnetic radiation device with the first electromagnetic radiation device.

16. The device of claim 14, further comprising:
a processor;
a baseband modem;
a radiofrequency front-end device;
a radiofrequency transceiver; and
wherein processor is configured to control the baseband modem to send a wireless signal over the multi-feed antenna device.
